(19) United States
(12) Patent Application Publication
(10) Pub. No.: US 2012/0051993 A1
(43) Pub. Date: Mar. 1, 2012

(54) Mitigation System In A Steam Methane Reformer Plant

(75) Inventors: William D. Lindberg, Pearland, TX (US); Alexander Rösch, Darmstadt (DE); Michael B. Wakim, Paris (FR)

(73) Assignees: L'Air Liquide Societe Anonyme Pour L'Etude Et L'Exploitation Des Procedes Georges Claude, Paris (FR); Air Liquide Large Industries U.S. LP, Houston, TX (US); Lurgi GmbH, Frankfurt (DE)

(21) Appl. No.: 12/868,406

(22) Filed: Aug. 25, 2010

(51) Int. Cl. B01D 53/72

(52) U.S. Cl. 423/245.3

(57) ABSTRACT

A method for volatile compound (VC) mitigation in a syngas production process is provided. This method includes providing a hydrocarbon reforming syngas production plant, this plant includes a reformer system comprising a primary fuel and oxidant stream, where part of this system is at low pressure, a steam inlet stream, and a primary combustion system for providing heat to the reformer system and producing a reformer flue gas stream, and a gaseous vent stream mainly composed of water and containing VC. This method also includes introducing at least a portion of the vent stream into one or more of the following: the primary fuel and oxidant stream; the steam inlet stream; the reformer flue gas stream.

### BACKGROUND

The present invention relates to a method to mitigate and reduce the volatile compound emissions (Volatile Organic Compounds (VOC) and other volatile compounds) of a Steam Methane Reformer (SMR) plant by routing the contaminated streams to the furnace and by using the heat of the furnace to destroy the organic compounds. Steam Methane Reformers are used to produce Synthesis Gas (syngas) from Methane and Steam and can be adjusted to produce pure hydrogen, methanol or other products. These endothermic reactions occur at high pressure and temperature releasing a lot of heat. Part of this heat is used to produce steam required by the process in one or more boilers.

To produce steam, the boiler will need high quality water which is usually mixed with condensates from the process and sent to a deaerator to remove oxygen, dissolved CO2 and other impurities. The process condensates will sometimes contain volatile organic and volatile inorganic compounds coming from the plant process, which might have been absorbed by the water during condensing. Typically those volatile compounds such as, but not limited to, methanol or ammonia would be stripped from the water and vented to the atmosphere by the deaerator. Other vent streams containing volatile compounds (e.g. vent stream from boiler blowdown drum, process condensate stripper) can be treated similarly.

In order to protect our environment, more and more states and countries have new legislation limiting and reducing atmospheric rejects by industrial plants. The first regulations were focusing on sulfuric acid or nitric oxides but today regulations are now implemented on volatile compound emissions (VOC & Other). The proposed invention describes how the heat from the furnace of an SMR could be used to destroy those pollutants and reduce the environmental impact of the plant.

### SUMMARY

The present invention is a method for Volatile Compound (VC, which includes VOC and other volatile compounds) mitigation in a syngas production process. This method includes providing a hydrocarbon reforming syngas production plant, this plant includes a reformer system comprising a primary fuel and oxidant stream, where part of this system is at low pressure, a steam inlet stream, and a primary combustion system for providing heat to said reformer system and producing a reformer flue gas stream, and a gaseous vent stream mainly composed of water and containing VC. This method also includes introducing at least a portion of said vent stream into one or more of the following: said primary fuel or oxidant stream; said steam inlet stream; said reformer box; said reformer flue gas stream.

### BRIEF DESCRIPTION OF THE FIGURES

FIG. 1 is a schematic representation of one embodiment of the present invention, indicating the VC containing stream being injected into the convective section of the heat recovery device.

FIG. 2 is a schematic representation of one embodiment of the present invention, indicating the VC containing stream being injected into the radiant section of the reformer unit.

FIG. 3 is a schematic representation of one embodiment of the present invention, indicating the VC containing stream is combined with an ambient air stream, introduced into convection section where it is preheated, then combined with a fuel stream, and then introduced into the reformer through burners, where it is combusted.

FIG. 4 is a schematic representation indicating a vertical VC containing stream injection manifold, in accordance with one embodiment of the present invention.

FIG. 5 is a schematic representation indicating a horizontal VC containing stream injection manifold, in accordance with one embodiment of the present invention.

FIG. 6 is a schematic representation indicating the blow down from the heat recovery device, in accordance with one embodiment of the present invention.

### DESCRIPTION OF PREFERRED EMBODIMENTS

The invention provides a number of technical solutions for using the heat of the reformer to destroy the volatile compounds (VC), which can be implemented in order to destroy the volatile compounds without a dedicated thermal or catalytic oxidizer.

As defined in this document, volatile compounds (VC), includes, but is not limited to, regulated volatile organic compounds, and other volatile compounds both organic and inorganic. This also includes, but is not limited to, ammonia and amines.

One solution is to route the VC-containing stream, composed mostly of water and VC, to the convection section (also called waste heat recovery section) of the plant. In order to ensure the full destruction of the VC, the higher the flue gas temperature at the injection point, the better. A preferred embodiment of this solution would be to inject the contaminated stream into the flue gas duct between the exit of the furnace and the first coil of the waste heat recovery section. In order to ensure high destruction efficiency the flue gas temperature should be above 750° C. and preferably above 850° C. The injection system could be designed with an injection grid located horizontally or vertically, co-current or counter current of the flue gas flow. The preferred solution would be to have a counter flow injection to minimize the impact on the downstream coils in the waste heat section. Additionally the invention could include the mixing of the vent with steam to avoid any condensation in the lines prior to and at the injection point.

In another embodiment of the solution, the contaminated stream would be injected in the bottom of the furnace in one or more places in the flue gas tunnels. Temperature at the injection point should be in the range of 1000° C. to 1060° C. In order to ensure the full destruction of the VC, beside the high temperature a sufficient residence time is important. The preferred distance to allow the maximum destruction of the VC would be ⅔^{rd} of the furnace length away from the flue gas exit. This would provide enough residence time to ensure destruction efficiency over 99%. The injection point should be carefully designed to avoid any impact on the refractory bricks of the flue gas tunnel and should ensure no liquid carry-over into the firebox.

In another embodiment, the contaminated stream may be injected on one or several side of the furnace at one or several locations. In the preferred solution the vent would be injected low enough not to disturb the burners flames but high enough to allow enough residency in the box and destruction of the VC. Tube protections would have to be engineered to avoid spraying the vent directly on the tubes and therefore cooling down the tubes, reducing the efficiency of the process reactions and leading to potential tube damage due to the water.

In another embodiment, the contaminated stream could be injected from the top of the furnace either in the fuel system of the burners or in a separate injection point. If injected in the fuel system a protection system would have to be put in place to ensure that no liquid water is sent to the burners.

The invention provides a number of technical solutions that could be implemented in order to destroy the volatile compounds without a dedicated thermal or catalytic oxidizer.

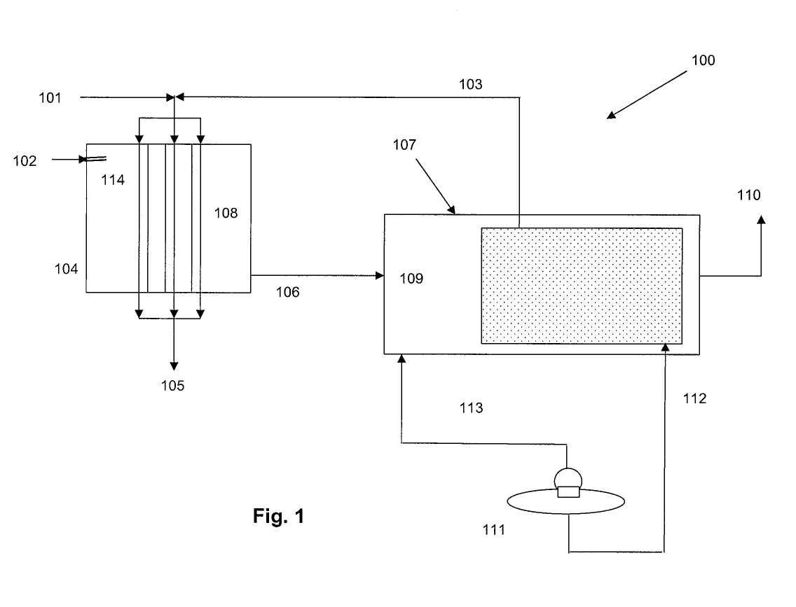

Turning now to FIG. 1, hydrocarbon reforming syngas production plant 100 is presented. Reformer feed stream 101 and steam stream (steam inlet stream) 103 are introduced into the catalyst tubes of reformer unit 104. Reformer unit 104 may be a Steam Methane Reformer (SMR) or an Autothermal Reformer (ATR). Hydrocarbon fuel (primary fuel) and oxidant stream 102 is introduced into the primary combustion system 114 in the shell side of reformer 104, where they are combusted thereby providing the temperature and heat required for the reforming process. The products of this combustion exit the shell side of reformer 104 as SMR flue gas stream 106.

Reformer feed stream 101 and steam stream (steam inlet stream) 103 are converted into syngas stream 105, which exits reformer 104 and proceeds to downstream cleanup, cooling and utilization (not shown). The SMR flue gas stream 106 then enters heat recovery device 107, where it indirectly exchanges heat with boiler feed water stream 112, thereby producing steam stream 103, and with the SMR flue gas stream exiting as cool flue gas stream 110. The two major sections of system 100 comprise a radiant section 108, and a convection section 109, with the convection section primarily comprised of heat exchange tubes.

Most of the dissolved oxygen, as well as other non-condensable gases, in boiler feed water stream 112 are removed in deaerator 111. The dissolved oxygen stream also contains volatile compounds (VC) which exit deaerator 111 in VC containing stream (gaseous vent stream) 113. In one embodiment, VC containing stream 113 is introduced into convective section 109 of heat recovery section 107. The idea would be to introduce the VCs into a section of the system wherein the pressure is relatively low and wherein the temperature and residence time are sufficiently high to destroy the VCs. By relatively low, it is understood that the pressure should be less than 2 bar, preferably less than 1.5 bar and could even be below atmospheric pressure.

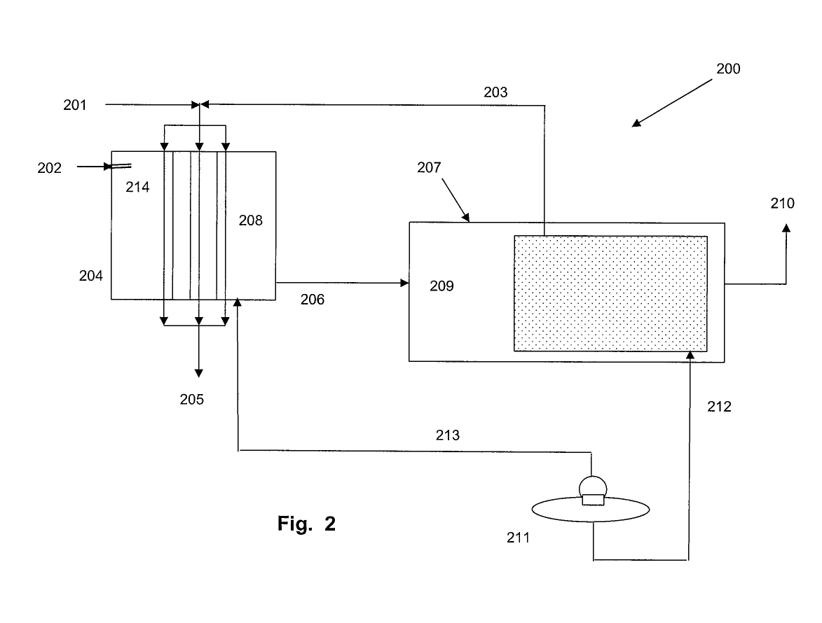

Turning now to FIG. 2, hydrocarbon reforming syngas production plant 200 is presented. Reformer feed stream 201 and steam stream (steam inlet stream) 203 are introduced into the catalyst tubes of reformer unit 204. Reformer unit 204 may be a Steam Methane Reformer (SMR) or an Autothermal Reformer (ATR). Hydrocarbon (primary fuel) fuel and oxidant stream 202 is introduced into the primary combustion system 214 in the shell side of reformer 204, where they are combusted thereby providing the temperature and heat required for the reforming process. The products of this combustion exit the shell side of reformer 204 as SMR flue gas stream 206.

Reformer feed stream 201 and steam stream (steam inlet stream) 203 are converted into syngas stream 205, which exits reformer 204 and proceeds to downstream cleanup, cooling and utilization. The SMR flue gas stream 206 then enters heat recovery device 207, where it indirectly exchanges heat with boiler feed water stream 212, thereby producing steam stream 203, and with the SMR flue gas stream exiting as cool flue gas stream 210. The two major sections of system 200 comprise a radiant section 208, and a convection section 209, with the convection section primarily comprised of heat exchange tubes.

Most of the dissolved oxygen, as well as other non-condensable gases, in boiler feed water stream 212 are removed in deaerator 211. The dissolved oxygen stream also contains volatile compounds (VC) which exit deaerator 211 in VC containing stream 213. In one embodiment, VC containing stream 213 is introduced into the radiant section of reformer unit 204. The idea would be to introduce the VCs into a section of the system wherein the pressure is relatively low and wherein the temperature and residence time are sufficiently high to destroy the VCs. By relatively low, it is understood that the pressure should be less than 2 bar, preferably less than 1.5 bar and could even be below atmospheric pressure.

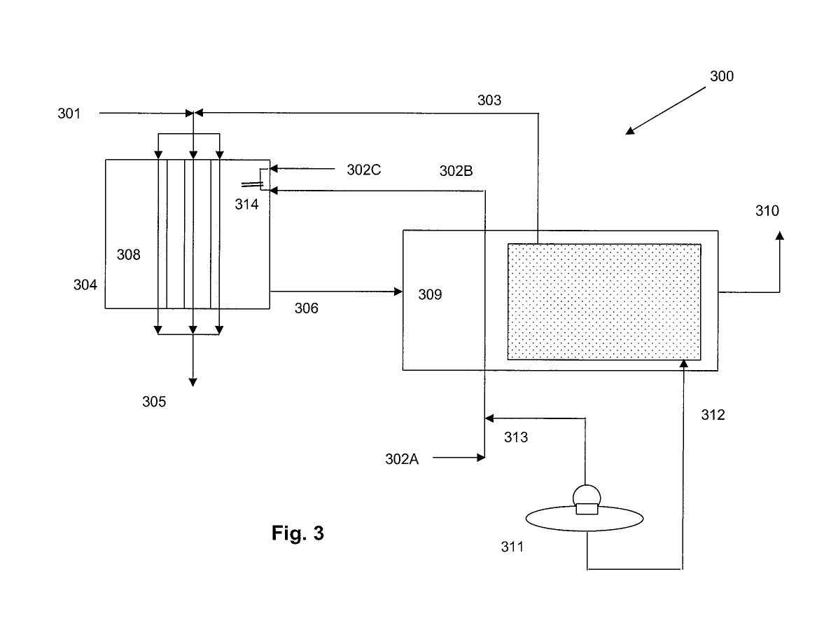

Turning now to FIG. 3, hydrocarbon reforming syngas production plant 300 is presented. Reformer feed stream 301 and steam stream (steam inlet stream) 303 are introduced into the catalyst tubes of reformer unit 304. Reformer unit 304 may be a Steam Methane Reformer (SMR) or an Autothermal Reformer (ATR).

Reformer feed stream 301 and steam stream (steam inlet stream) 303 are converted into syngas stream 305, which exits reformer 304 and proceeds to downstream cleanup, cooling and utilization. The SMR flue gas stream 306 then enters heat recovery device 307. The two major sections of system 300 comprise a radiant section 308, and a convection section 309, with the convection section primarily comprised of heat exchange tubes. Within heat recovery device 307, the combined stream indirectly exchanges heat the above combined ambient air stream 302A and VC containing stream 313, and with boiler feed water stream 312, thereby producing steam stream 303, and with the SMR flue gas stream exiting as cool flue gas stream 310.

Most of the dissolved oxygen, as well as other non-condensable gases, in boiler feed water stream 312 are removed in deaerator 311. The dissolved oxygen stream also contains volatile compounds (VC) which exit deaerator 311 in VC containing stream 313. A deaerator will typically operate at between 0.4 bar and 0.7 bar, so stream 313 will be at an equivalent low pressure. VC containing stream 313 is combined with ambient air stream 302A, and the combined stream is introduced into radiant section 308. In radiant section 308, the combined stream is in indirect heat exchange with hot flue gas stream 306, thereby producing preheated oxidant stream 302A. Preheated oxidant stream 302A is combined with fuel stream 302C, which are then introduced into the shell side of reformer 304, where they are combusted thereby providing the temperature and heat required for the reforming process. The products of this combustion exit the shell side of reformer 304 as SMR flue gas stream 306.

The idea would be to introduce the VCs into a section of the system wherein the pressure is relatively low and wherein the temperature and residence time are sufficiently high to destroy the VCs. By relatively low, it is understood that the pressure should be less than 2 bar, preferably less than 1.5 bar and could even be below atmospheric pressure.

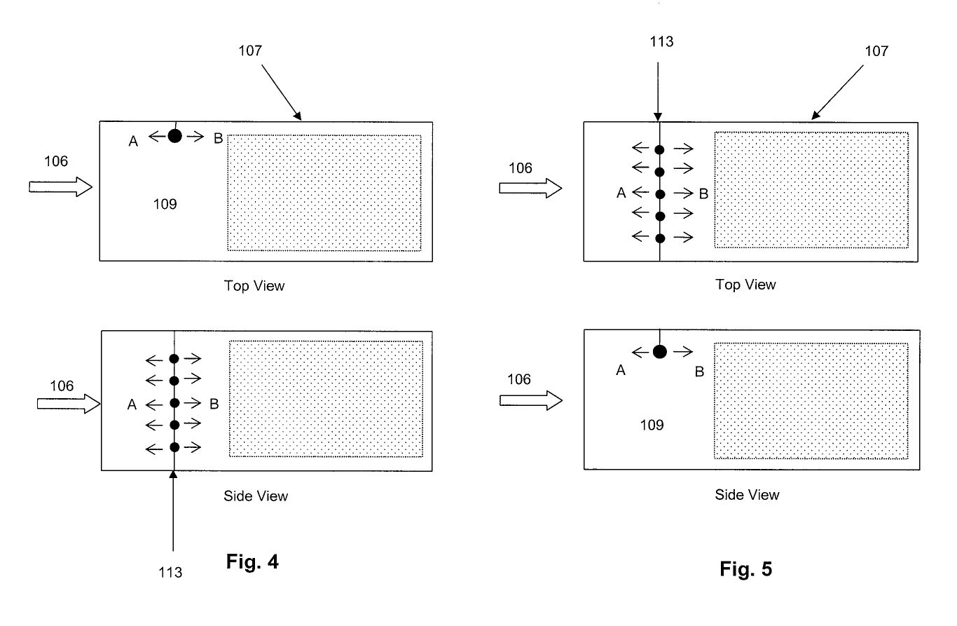

FIGS. 4 and 5 are illustrative embodiments of two possible ways in which VC containing stream 113 may be introduced into convective section 109 of heat recovery section 107. FIG. 4 illustrates a vertical injection manifold, and FIG. 5 illustrates a horizontal injection manifold. Additional embodiments are envisioned, and are within the ability of one of ordinary skill in the art to develop and implement without undue experimentation.

As indicated in FIG. 4, VC containing stream 113 is introduced into convective section 109 in a vertical injection manifold. This vertical manifold may have forward facing injection ports (A) or rearward facing injection ports (B). These ports may inject VC containing stream 113 at a positive or negative angle to the horizontal, as required for optimum distribution and mixing in SMR flue gas stream 106.

VC containing stream 113 may be injected on one or several sides of convective section 109, at one or several locations. Special care should be taken to protect heat exchangers close to the injection ports to avoid spraying the vent directly on the exchanger tubes and therefore cooling down the tubes, reducing the efficiency and leading to potential tube damage due to the water.

As indicated in FIG. 5, VC containing stream 113 is introduced into convective section 109 in a horizontal injection manifold. This horizontal manifold may have forward facing injection ports (A) or rearward facing injection ports (B). These ports may inject VC containing stream 113 at a positive or negative angle to the vertical as required for optimum distribution and mixing in SMR flue gas stream 106. Special care should be taken to protect heat exchangers close to the injection ports to avoid spraying the vent directly on the exchanger tubes and therefore cooling down the tubes, reducing the efficiency and leading to potential tube damage due to the water.

VC containing stream 113 may be injected from near the top of convective section 109, or at any point above the horizontal midpoint of convective section 109.

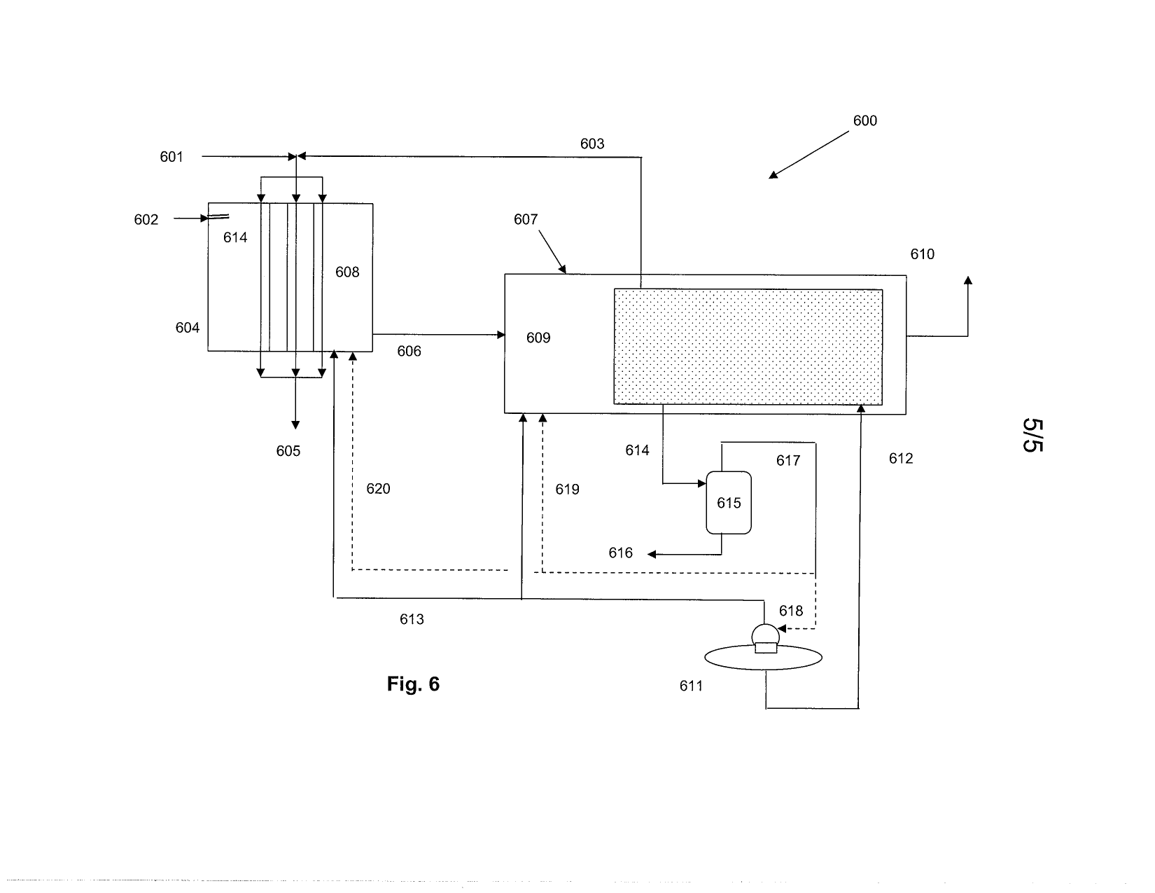

Turning now to FIG. 6, hydrocarbon reforming syngas production plant 600 is presented. Reformer feed stream 601 and steam stream (steam inlet stream) 603 are introduced into the catalyst tubes of reformer unit 604. Reformer unit 604 may be a Steam Methane Reformer (SMR) or an Autothermal Reformer (ATR). Hydrocarbon (primary fuel) fuel and oxidant stream 602 is introduced into the primary combustion system 614 in the shell side of reformer 604, where they are combusted thereby providing the temperature and heat required for the reforming process. The products of this combustion exit the shell side of reformer 604 as SMR flue gas stream 606.

Reformer feed stream 601 and steam stream (steam inlet stream) 603 are converted into syngas stream 605, which exits reformer 604 and proceeds to downstream cleanup, cooling and utilization. The SMR flue gas stream 606 then enters heat recovery device 607, where it indirectly exchanges heat with boiler feed water stream 612, thereby producing steam stream 603, and with the SMR flue gas stream exiting as cool flue gas stream 610. The two major sections of system 600 comprise a radiant section 608, and a convection section 609, with the convection section primarily comprised of heat exchange tubes.

Most of the dissolved oxygen, as well as other non-condensable gases, in boiler feed water stream 612 are removed in deaerator 611. The dissolved oxygen stream also contains volatile compounds (VC) which exit deaerator 611 in VC containing stream 613. In one embodiment, the blow down stream 614 from heat recovery device 607 is introduced into a phase separation device 615, where it is separated into a high solids content waste stream 616 and a vapor stream 617 which may contain VCs. Vapor stream 617 may then be introduced into deaerator 611, after which VC containing stream 613 is introduced into either the radiant section 608 or the convective section 609 of reformer unit 604. In one embodiment, VC containing stream 613 is introduced into both the radiant section 608 and the convective section 609 of reformer unit 604. Vapor stream 617 may then be introduced directly into either the radiant section 608 or the convective section 609 of reformer unit 604. In one embodiment, vapor stream 617 is introduced into both the radiant section 608 and the convective section 609 of reformer unit 604.

What is claimed is:

1. A method for volatile compound (VC) mitigation in a syngas production process comprising;
providing a hydrocarbon reforming syngas production plant comprising
a reformer system comprising a primary fuel and oxidant stream, where part of this system is at low pressure, a steam inlet stream, and a primary combustion system for providing heat to said reformer system and producing a reformer flue gas stream,
a gaseous vent stream mainly composed of water and containing VC, and
introducing at least a portion of said vent stream into one or more of the following: said primary fuel and oxidant stream; said steam inlet stream;
said reformer flue gas stream.

2. The method of claim 1, wherein the mean fluid temperature into which said vent stream is introduced is between about 100 C and about 1000 C.

3. The method of claim 1, wherein said low pressure is less than 2 bar.

4. The method of claim 1, wherein said low pressure is 1.5 bar.

5. A method for volatile compound (VC) mitigation in a syngas production process comprising;
providing a hydrocarbon reforming syngas production plant comprising
a flue gas stream,
a gaseous vent stream mainly composed of water and containing VC,
a furnace section or radiant section and a waste heat recovery section or convection section and
a fuel and a combustion air system to provide heat to the process where part of this system is at low pressure
introducing at least part of said vent stream in a step of the process where fluids temperature is between 100 C and 1000 C.

6. The method of claim 5, wherein said low pressure is less than 2 bar.

7. The method of claim 5, wherein said low pressure is 1.5 bar.

8. The method of claim 5 where the syngas production process is a steam methane reforming process

9. The method of claim 5 where the syngas production process is an auto-thermal reforming process in which the hydrocarbon feedstock is first heated in a preheating furnace comprising at least a radiant and a convection section prior to entering the auto-thermal reformer.

10. The method of claim 5, wherein said vent stream is composed of a gaseous stream coming from the stripping section of a deaerator.

11. The method of claim 5, wherein said vent stream is blended with a steam stream prior to introduction into said process.

12. The method of claim 5 where the injection of said vent stream is done via an injection grid comprising of at least one injection port.

13. The method of claim 5, wherein the injection of the said vent stream is done in said convection section.

14. The method of claim 13, wherein the injection of the said vent stream is co-current with said Flue gas stream.

15. The method of claim 13, wherein the injection of the said vent stream is counter-current with said Flue gas stream.

16. The method of claim 13, wherein the injection of the said vent stream is done near the area of the convection section with the highest temperature.

17. The method of claim 13, wherein said SMR flue gas stream has a temperature above about 750 C.

18. The method of claim 13, wherein said SMR flue gas stream has a temperature above about 850 C.

19. A method of claim 5, wherein the injection of the said vent stream is done in said radiant section.

20. The method of claim 19, wherein the injection of the said vent stream is done from one of the vertical side of the radiant section.

21. The method of claim 19, wherein the injection of the said vent stream is done from the top side of the radiant section.

22. The method of claim 19, wherein the injection of the said vent stream is done from the bottom side of the radiant section.

23. The method of claim 22, wherein said convection section has a beginning and said radiant section has an opposite wall located on the opposite side from the said beginning, and the distance between said convection section beginning and said vent stream injection is ⅔ or the distance between said convection section beginning and said opposite wall.

24. The method of claim 5, wherein the injection of the said vent stream is done in said fuel system.

25. The method of claim 5, wherein the injection of the said vent stream is done in said combustion air system.

26. The method of claim 25, wherein said combustion air system comprised at least one step of air preheating.
